(19) United States
(12) Patent Application Publication
(10) Pub. No.: US 2016/0135166 A1
(43) Pub. Date: May 12, 2016

(54) SYSTEM AND METHOD FOR EXPORTING REAL-TIME USER EQUIPMENT AND BEARER STATE INFORMATION

(71) Applicants: Bruce CILLI, Atlantic-Highlands, NJ (US); Charles PAYETTE, Oceanport, NJ (US); Edward GRINSHPUN, Freehold, NJ (US)

(72) Inventors: Bruce CILLI, Atlantic-Highlands, NJ (US); Charles PAYETTE, Oceanport, NJ (US); Edward GRINSHPUN, Freehold, NJ (US)

(21) Appl. No.: 14/534,491

(22) Filed: Nov. 6, 2014

(51) Int. Cl. H04W 72/04; H04W 8/24; H04W 8/08; H04W 24/02

(52) U.S. Cl. CPC H04W 72/048; H04W 24/02; H04W 8/24; H04W 8/08

(57) ABSTRACT

A mechanism to export user equipment (UE) and/or bearer state information from a E-UTRAN Node B (eNB) mobility management entity (MME) and combine this state information with globally recognizable identifiers for the UE and/or bearer. The state information is collected by an external server and provided to application service providers (ASPs) and wireless service providers (WSP) to more effectively deliver content to the UE by adjusting throughput. The mechanism involves only a single query to the MME, for every UE and/or bearer, as opposed to one inquiry for every state information update on a per UE and/or per bearer basis, in order to not overwhelm network traffic.

### BACKGROUND OF THE INVENTION

1. Field of the Invention

Example embodiments relate generally to a system and method for exporting real-time user-equipment (UE) and bearer state information for a 3^{rd} Generation Partnership Project Long-Term Evolution (3GPP LTE) network to more effectively deliver content to users and improve and/or optimize the network.

2. Related Art

FIG. 1 is a conventional 3^{rd} Generation Partnership Project Long-Term Evolution (3GPP LTE) network 10. The network 10 includes an Internet Protocol (III Connectivity Access Network (IP-CAN) 100 and an IP Packet Data Network (IP PDN)1001, The IP-CAN 100 generally includes a serving gateway (SGW) 101; a packet data network (PDN) gateway (PGW) 103; a policy and charging rules function (PCRF) 112; a mobility management entity (MME) 108 and an eNB 105 (i.e., base station, for the purposes herein the terms base station and eNB are used interchangeably). The IP-PDN 1001 may contain application functions (AF) 114; Although not shown, the IP-PDN 1001 portion of the EPS may include application or proxy servers, media servers, email servers, etc.

Within the IP-CAN 100, the eNB 105 is part of what is referred to as an Evolved Universal Mobile Telecommunications System (UMTS) Terrestrial Radio Access Network (EUTRAN), and the portion of the IP-CAN 100 including the SGW 101, the PGW 103, the PCRF 112, the AF 114, and the MME 108 is referred to as an Evolved Packet Core (EPC). Although only a single eNB 105 is shown in FIG. 1, it should be understood that the EUTRAN may include any number of eNBs. Similarly, although only a single SGW, PGW and MME are shown in FIG. 1, it should be understood that the EPC may include any number of these core network elements.

The eNB 105 provides wireless resources and radio coverage for UEs including UE 110. For the purpose of clarity, only one UE is illustrated in FIG. 1. However, any number of UEs may be connected (or attached) to the eNB 105. The eNB 105 is operatively coupled to the SGW 101 and the MME 108.

The SGW 101 routes and forwards user data packets, while also acting as the mobility anchor for the user plane during inter-eNB handovers of UEs. The SGW 101 also acts as the anchor for mobility between 3^{rd} Generation Partnership Project Long-Term Evolution (3GPP LTE) and other 3GPP technologies. For idle UEs, the SGW 101 terminates the downlink data path and triggers paging when downlink data arrives for UEs.

The PGW 103 provides connectivity between the UP 110 and the external packet data networks (e.g., the IP-PDN) by being the point of entry/exit of traffic for the UE 110. As is known, a given UE may have simultaneous connectivity with more than one PGW for accessing multiple PDNs.

The PGW 103 also performs policy enforcement, packet filtering for UEs, charging support, lawful interception and packet screening, each of which are well-known functions. The PGW 103 also acts as the anchor for mobility between 3GPP and non-3GPP technologies, such a s Worldwide Interoperability for Microwave Access (WiMAX) and 3^{rd} Generation Partnership Project 2 (3GPP2 (code division multiple access (CDMA) 1X and Enhanced Voice Data Optimized (EvDO)).

Still referring to FIG. 1, the eNB 105 is also operatively coupled to the MME 108. The MME 108 is the control-node for the EUTRAN, and is responsible for idle mode UE paging and tagging procedures including retransmissions. The MME 108 is also responsible for choosing a particular SGW for a UE during initial attachment of the UE to the network, and during intra-LTE handover involving Core Network (CN) node relocation. The MME 108 authenticates UEs by interacting with a Home Subscriber Server (HSS), which is not shown in FIG. 1.

Non Access Stratum (NAS) signaling terminates at the MME 108, and is responsible for generation and allocation of temporary identities for UEs. The MME 108 also checks the authorization of a UE to camp on a service provider's Public Land Mobile Network (PLMN), and enforces UE roaming restrictions. The MME 108 is the termination point in the network for ciphering/integrity protection for NAS signaling, and handles security key management.

The MME 108 also provides control plane functionality for mobility between LTE and 2G/3G access networks with the S3 interface from the SGSN (not shown) terminating at the MME 108.

The Policy and Charging Rules Function (PCRF) 112 is the entity that makes policy decisions and sets charging rules. It has access to subscriber databases and plays a role the 3GPP architecture as specified in 3GPP TS 23.203 “Policy and Charging Control Architecture.”

The Application Function (AF) 114 is an entity that is application aware and is an ultimate receiver of exported eNB data that may be used to more effectively deliver content to the UE 110 to improve and/or optimize the network 100. AF 114 is generally positioned in the IP Packet Data Network 1001 or alternatively inside the UE 110.

Over the top mobile application services, especially a variety of mobile video services for both on-demand and real time live video, can greatly benefit from real time knowledge about user equipment (UE) wireless link throughput. This information is conventionally available at the E-UTRAN Node B (eNB) 105 level, though there is currently no means for collecting this information and providing it to application service providers (ASP) and/or wireless service providers (WSP). That is to say the LTE eNB 105 does not have a mechanism to export data in real time related to individual UEs and/or the UE bearers (where a bearer may be understood to be a link or channel used to exchange information to run application on the UE). Furthermore, the eNB 105 does not “know” the UE by any identifier that would be recognizable to nodes outside of the eNB 105 and the network nodes within close proximity to eNB 105. For instance, eNB 105 does not know the Internet protocol (IP) address, nor international mobile subscriber identity (IMSI), of the UE.

Conventionally, 3GPP TR 23.705, section 6.1.5.2 focuses on solution to report congestion levels of the eNB 105. For out of band signaling of cell congestion level by eNB 105, TR 23.705 proposes to use either an existing eNB-MME interface or an OAM function designated to report congestion. However both options do not scale well to the needs of reporting real time UE/bearer state. That is to say, congestion level changes can be frequent, and therefore the quantity of messages to the mobility management entity (MME) 108 is limited as is the amount of data per message. Specifically, it would be unrealistic to require all per UE/bearer state data to pass through the MME 108. The MME 108 serves many eNBs 105 which in turn serves many UEs 110, each having one or more bearers with expected frequent bearer state changes. Having this large number of state update messages from each eNB 105 travel through MME 108 would be detrimental to overall network load. Likewise, it is impractical for an OAM function to receive and process real time UE/bearer information, and the mechanism by which an OAM determines congestion is not contained in TR 23.705.

### SUMMARY OF INVENTION

Example embodiments provide a mechanism to export a wide range of user equipment (UE) and/or bearer state information from a E-UTRAN Node B (eNB)/mobility management entity (MME) and combine this state information with globally recognizable identifiers, such as an IP address or IMSI identifier (as opposed to locally recognized identifiers used only by eNB and other local nodes). The state information may be collected by an internal server and provided to application service providers (ASPs) to more effectively deliver content to the UE by knowing data rates the UE is likely to receive, knowing the type of congestion the UE may experience, etc. The state information may also be used by wireless service providers (WSP) to troubleshoot and improve and/or optimize the network. The mechanism involves only a single query to the MME, for every UE and/or bearer, as opposed to one inquiry for every state information update on a per UE and/or per bearer basis, in order to not overwhelm network traffic.

In one embodiment, a method of exporting user equipment (UE) and/or bearer information, may comprise: receiving, at a processor of a network node, UE and/or bearer state information and at least one locally recognized UE and/or bearer identifier from a base station for at least one UE and/or bearer of the network; mapping, at the processor, the locally recognized UE and/or bearer identifier to a globally recognized UE and/or bearer identifier, the globally recognized UE and/or bearer identifier being an identifier of a UE and/or bearer that is recognized by network equipment outside of the network; and exporting, at the processor, the UE and/or bearer state information and the globally recognized UE and/or bearer identifier to a network element.

In one embodiment, a method of adjusting throughput using bearer information, may comprise: receiving, at a processor of first network node from a second network node, UE and/or bearer state information and at least one globally recognized UE and/or bearer identifier associated with a UE and/or bearer associated with a UE, the globally recognized UE and bearer identifier being an identifier of a UE and/or bearer that is recognized by network equipment outside of the network; and adjusting, at the processor of the first network node, throughput for the UE and/or bearer based on the received UE and/or bearer stale information and the at least one globally recognized UE and/or bearer identifier.

In one embodiment, a network node, may comprise: a communication interface configured to receive UE and/or bearer state information and at least one locally recognized UE and/or bearer identifier from a base station for at least one UE and/or bearer of the network; and a processor configured to, map the locally recognized UE and/or bearer identifier to a globally recognized UE and/or bearer identifier, the globally recognized UE and/or bearer identifier being an identifier of UE and/or bearer that is recognized by network equipment outside of the network, wherein the communication interface exports the UE and/or bearer state information and the globally recognized UE and/or bearer identifier to a network element.

In one embodiment, a first network node, may comprise: a communication interface configured to, receive, from a second network node, UE and/or bearer state information and at least one globally recognized UE and/or bearer identifier associated with a UE and/or bearer associated with a UE, the globally recognized UE and/or bearer identifier being an identifier of a UE and/or bearer that is recognized by network equipment outside of the network; and a processor configured to, adjust throughput for the UE and/or bearer based on the received UE and/or bearer state information and at least one globally recognized UE and/or bearer identifier.

### BRIEF DESCRIPTION OF THE DRAWINGS

The above and other features and advantages of example embodiments will become more apparent by describing in detail, example embodiments with reference to the attached drawings. The accompanying drawings are intended to depict example embodiments and should not be interpreted to limit the intended scope of the claims. The accompanying drawings are it to be considered as drawn to scale unless explicitly noted.

FIG. 1 is a conventional 3^{nd} Generation Partnership Project Long-Term Evolution (3GPP LTE) network;

FIG. 2 is a 3GPP LTE network, in accordance with an example embodiment;

FIG. 3 is a diagram of a network insight function (NIF), in accordance with an example embodiment;

FIG. 4 is a flowchart of a method of exporting real-time user equipment (UE) and/or bearer state information, in accordance with an example embodiment;

FIG. 5A is a communication diagram describing different alternatives for the NIF server to collect data, in accordance with an example embodiment; and

FIG. 5B is a communication diagram describing a method of exporting real-time user equipment (UE) and/or bearer state information, in accordance with an example embodiment.

### DETAILED DESCRIPTION

While example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Before discussing example embodiments in more detail, it is noted that some example embodiments are described as processes or methods depicted a s flowcharts. Although the flowcharts describe the operations as sequential processes, many of the operations may be performed in parallel, concurrently or simultaneously. In addition, the order of operations may be re-arranged. The processes may be terminated when their operations axe completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium, such as a non-transitory storage medium. A processor(s) may perform the necessary tasks.

Specific structural and functional details disclosed herein axe merely representative for purposes of describing example embodiments. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description are presented in terms of software, or algorithms and symbolic representations of operation on data hits within a computer memory. These descriptions and representations are the ones by which those of ordinary skill in the art effectively convey the substance of their work to others of ordinary skill in the art. An algorithm, as the terra is used here, and, as it is used generally, is conceived to be a self consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes include routines, programs, objects, components, data structures, etc., that perform particular tasks or implement particular abstract data types and be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of program storage medium or implemented over some type of transmission medium. The program storage medium may be any non-transitory storage medium such as magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

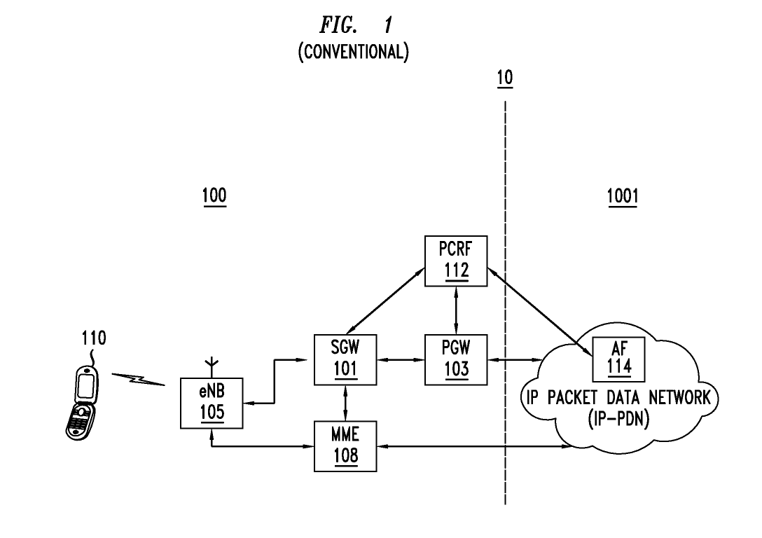

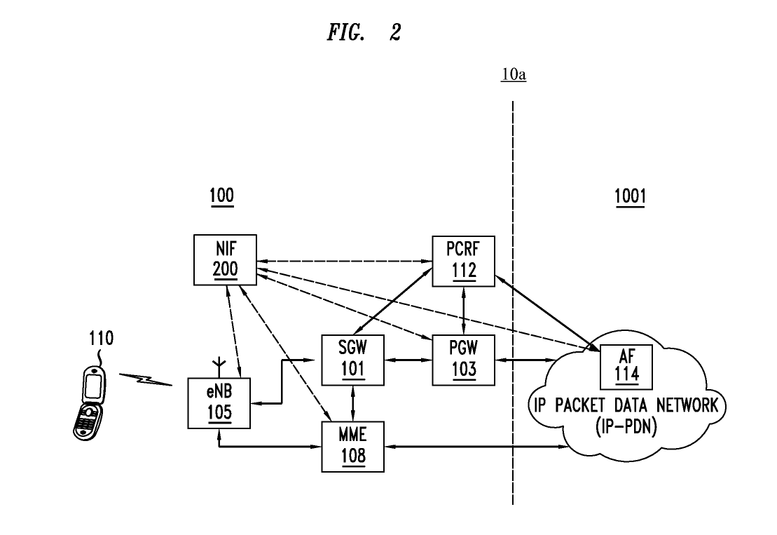

FIG. 2 is a 3GPP UTE network 10a, in accordance with an example embodiment. The network 10a is the same as network 10 (FIG. 1), with the following differences. A network insight function (NIF) 200, which may be an external server, may be added to the network 10a. It should be understood that NIF 200 may alternatively be located in an existing network node (rather than as a stand-alone server), and NIF 200 may also be located in a remote location such that NIF 200 is not in IP-CAN 100 (though, for more effective response time and security reasons, it is preferred that NIF 200 is located somewhere within IP-CAN 100).

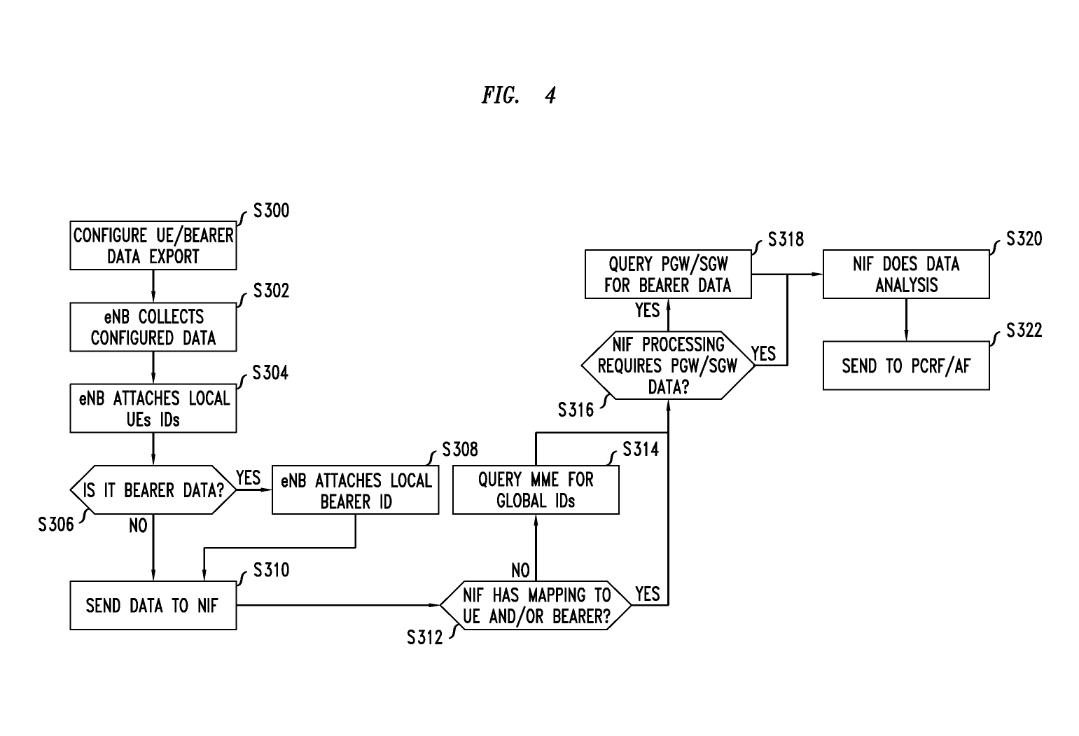

In general, NIP 200 may collect UE and/or bearer identification and state information from eNB 105 and MME 108, and NIF 200 may optionally share this information with PGW 103, PCRF 112 and/or AF 114 in order to more effectively deliver content to the UE. This information exchange is described in greater detail in relation to FIGS. 4-6, described below.

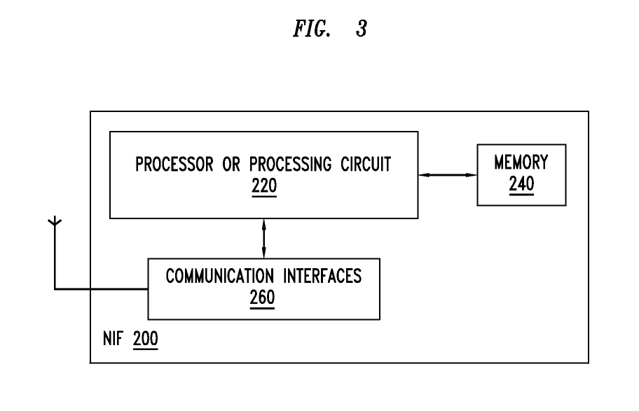

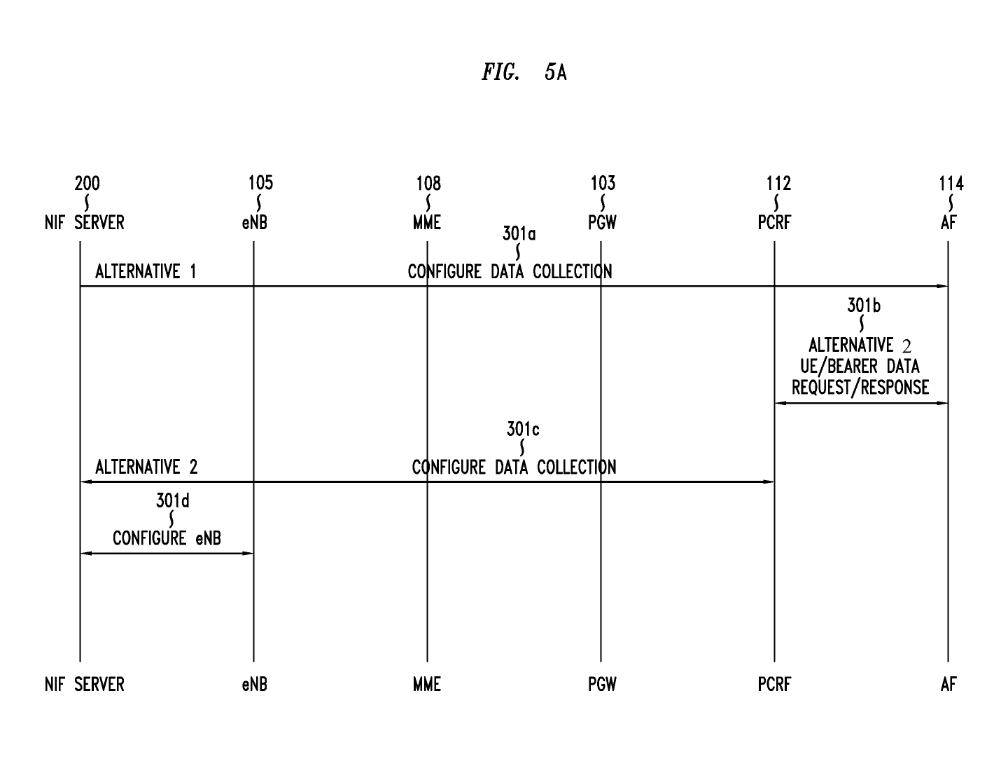

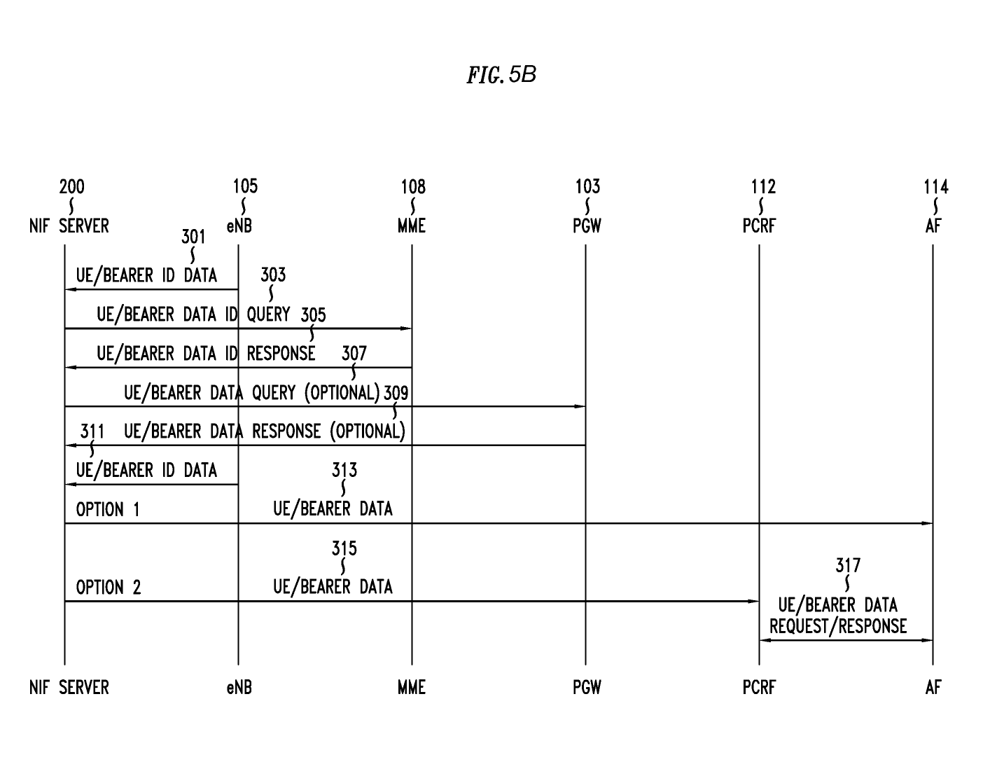

FIG. 3 is a diagram of a network insight function (NIF) 200, in accordance with an example embodiment. NIF 200 may include a communication interface 260 that provides communication exchange between eNB 105, MME 108, PGW 103, PCRF 112 and/or AF 114. NIF 200 may also include a server processor 220 that performs process functions of NIF 200, as described in more detail in relation to FIGS. 4 and 5 (below). Memory 240 may be included to store and buffer data and information that is received, processed, and transmitted by NIF 200.

With regard to FIGS. 2 and 3, it should also be understood that NIF 200 may be contained within an existing network node, such as within eNB 105. MME 108, PGW 103, or any other conventionally available node, as opposed to being a dedicated, stand alone NIF server 200, as shown in FIGS. 2 and 3.

### General Methodology:

The general methodology of an example embodiment is to export data (identification information and state information) directly from the eNB 105 on a UE 110/bearer basis to NIF 200. NIF 200 may correlate the data into internet protocol (IP) address identification, international mobile subscriber identity (IMSI), or another externally identifiable ID. If the data represents a bearer, it may be further identified with criteria specifying the bearer. UE/bearer state data may include throughput, channel condition information, distribution of physical resource block (PRB) to modulation and coding scheme (MCS) values, and PRB retransmissions. However, the eNB 105 has conventionally been designed to not require externally visible IDs of the UEs and/or bearers, as this information instead resides in the MME 108. To export data about the. UEs that would be externally meaningful, the eNB internal identification of the UEs must be exported and then correlated to a globally understood ID outside the eNB 105.

The eNB 105 is aware of the eNB UE S1 application protocol (S1AP) ID and the MME UE S1AP ID, which can combine to uniquely identify a UE. The eNB UE S1AP ID is assigned by the eNB in order for the eNB 105 to locally be able to recognize each UE 110, and likewise the MME UE S1AP ID is assigned by the MME in order for the MME 108 to locally be able to recognize each UE 110. Therefore, eNB may be requested to report UE data with the eNB UE S1AP ID and the MME UE S1AP ID. Furthermore, the MME ID may also be provided to inform the NIF 200 as to which MME 108 may be the holder of the relevant information describing the UE and/or bearer.

Since MME 108 is the entity to assign the MME UE S1AP ID, there is uniqueness in the combination of the MME ID and the MME, UE S1AP ID. So, it may be optional to report the MME UE S1AP ID and the MME ID.

NIP 200 may then query the MME 108 that is identified by MME ID with the MME UE S1AP ID, and optionally eNB UE S1AP ID, in order to retrieve IP address and/or IMSI identifiers (or, another unique identifier). Protocol to exchange this information could be via a representational state transfer (REST) architecture, such as a representational state transfer application programming interface (“RESTful” API), or some other standardized messaging format. State information data regarding individual bearers may be provided as long as the bearer is identifiable externally. In this case, additionally the E-UTRAN Radio Access Bearer identifier (E RAB ID) may be reported by eNB 105. NIF 200 may use this ID with the IDs of the UE to determine Evolved Packet System bearer identification (EPS bearer ID) from the MME 108. Alternatively, it could retrieve the classification criteria to which the bearer was created from the MME 108. The E RAE ID and the EPS bearer ID are often the same, though this is not mandatory. NIF 200 may also receive information from PGW 103 using the EPS bearer ID returned by MME 108 with a n associated IMSI. PGW 103 may map the EPS ID to the classification criteria to which the bearer was created.

After NIP 200 has queried MME 108, for the IP address and/or IMSI for UE 110, there is not a need to go back and re-query MME 108 as future data records are received from the same eNB 105 regarding a particular UE and/or bearer, as long as UE S1AP ID, MME UP S1AP ID and MME ID information reported by eNB 105 does not change. The same holds true for bearers associated with UEs 110. If desired, this mechanism of exporting UE and/or bearer data could he standardized.

Therefore, NIP 200 in network 100 may be established to collect real-time identification and state information data regarding UEs 110 and the UE's associated bearers in a performance efficient and scalable manner. This data may be collected from eNB 105 for UEs 110 connected to the eNB 105. For UE related statistics/data, this information would be sent along with the associated eNB UE S1AP ID and the MME UE S1AP ID to uniquely identify the UE 110, along with the MME ID of the MME 108 which maintains information regarding the UE 110, UE related data could be channel conditions (SINR), throughput, distribution PRBs to MCS, etc. A standardized interface to export this data is not currently defined, and therefore the data may be sent any number of ways, including over TCP/IP or UDP/IP, assuming an API is defined.

### Example Method Steps:

FIG. 4 is a flowchart of a method of exporting real-time user equipment (UE) and/or bearer state information, and FIGS. 5A/B are communication diagrams describing the communication exchange of this method, in accordance with an example embodiment. The following description describes both of these figures at the same time.

As shown in FIG. 5A, AF 114 may send a AF request message 301a to the NIF server 200 indicating that NIF 200 should collect identification and state information data for either a single UE, a set of UEs, or all UEs (the remainder of this discussion will assume that only one UE 110 is involved in this method for simplicity, though it should be understood that multiple UEs could be included in the method). The AF request message may contain an identifier of the UE which may include an IMSI(s) or IP address(es). Additionally, to identify specific bearers, the AF request message may contain the IP flow classification criteria (which may include any of the classification criteria: source IF address range, destination IP address range, source port range, destination port range, protocol type, QoS indicator (e.g. DSCP for IPv4) IPSec Security Parameter Index (SPI) and Flow Label (IPv6 only) for each bearer of interest. Furthermore, the AP request message may identify the type of information that NIF 200 is to extract from eNB 105 pertaining to UE 110, as described herein in more detail.

Alternative to AF 114 sending the AF request message to NIF 200, AF 114 may instead send the AF request message 301b to PCRF 112 to start the process of collecting identification and state information data from eNB 105 pertaining to UE 110. As part of this alternative, PCRF 112 may forward the AF request message 301c to NIP 200.

In using either Alternative 1 (AF 114 sending message 301a direct to NIF 200) or Alternative 2 (AP 114 sending message 301b to PCRF 112 and the PCRF 112 in turn forwarding the request message 301c to the NIF), NIF 200 responds to these requests by configuring eNB 105 (which corresponds to step S300 of FIG. 4), This configuration. process (pertaining to communication exchange 301d of FIG. 5A, and step S300 of FIG. 4) includes NIP 200 requesting identification and state information configuration data from eNB 105 pertaining to a time period t (where t=1 second, for instance), that may include: quality-of-service class indicator (QCI) of the bearer (can be transmitted once per bearer lifecycle), average indicator of channel conditions (for example average SINR, average CQI as reported by UE, average MCS as used by scheduler, per bearer average number of transmitted bits sent (TBS) slope index (which may be calculated as an average [TES/number of physical resource blocks, or PRBs] ratio calculated for each transmission time interval, or TTI; alternatively, TES slope may be calculated from 30-PP TS36.213 tables Tables 7.1.7.1-1 and Table 7,1.7.2.1-1 as a slope of linear approximation using statistical methods like a least squares method), the UE and/or bearer state information includes at least one of average number of bits per second successfully transmitted from or to the UE, average number of bits per second transmitted for the bearer, average number of bits per second transmitted to or from the UE, average number of physical resource blocks (PRBs) allocated by scheduler per second for the bearer, average number of physical resource blocks (PRBs) allocated by scheduler per second for the UE, average number of PRBs allocated for data retransmissions for the bearer, average number of PRBs allocated for data retransmissions for the UE, average size of buffered at base station data waiting to be wirelessly transmitted, cell ID and/or a buffer status report. This state information could have a direction associated indicating whether it is uplink or downlink.

Alternative to step S300, eNB 105 may be pre-configured to send the identification and state information configuration data (described above) to NIF 200, as opposed to NIF 200 prompting eNB 105 to do so. This may be accomplished by pre-configuring eNB 105 to retain an address of NIP 200 so that the configuration data is sent to NIF 200.

In either event, whether eNB 105 is pre-configured to transmit identification and state information configuration data to NIF 200, or in the event that NIF 200 initiates a communication exchange 301d to obtain the configuration data, the configuration data may be sent either on a periodic basis or when of the exported data items reaches a configured threshold.

As shown in S302, eNB 105 collects the requested identification and state information configuration data for export and associates the configuration data with appropriate UE and/or bearer identifiers. This collection of the requested configuration data may also include preliminary processing which may include averaging the configuration data over a period of time. The data collection by the eNB is illustrated in message 301.

As shown in S304, the configuration data may be associated with a local UE identifier (it should be understood that the term “UE identifier” may in fact be a pairing of identifiers, as opposed to a. singular identifier, as described herein). The UE identifier may include one or more of the following: (1) eNB UE S1AP ID (an eND application protocol identifier allocated by eNB 105 as defined in 3GPP TS 36.401) and the MME UE S1AP ID (an MME application protocol identifier which is allocated by MME 108 and defined in 36PP TS 36.401), (2) MME UE S1AP ID and MME Id (MME service provider network identifier as defined in 3GPP TS 23.003), or (3) eNB BE S1AP ID and eNB Id (eNB service provider network identifier as defined in 3GPP TS 23.003, which may be the E-UTRAN Cell Identity (Ed) or E-UTRAN Cell Global Identification (ECGI)). It is well-known that these local identifiers reside at eND 105 and/or MME 108, though this information is not conventionally available at AF 114 or other entities outside of the MME and eNB.

As shown in step S306, eNB 105 determines whether requested identification and state information configuration data is bearer data (versus UE 110 data). In the event the configuration data is bearer data, in step S308 the individual bearer identifier (i.e., E-RAB Id) should be appended to the configuration data.

Once the state information configuration data is associated with the UE identifiers and bearer identifiers in step S308, if need be), in step S310 the configuration data with associated UE and/or bearer identifiers is transmitted to NIF 200. The MME identifier obtained from eNB 105 (and described above) may be appended to the configuration data to inform NIF 200 which MME 108 is associated with the UE and/or bearers.

As shown in S312, NIP 200 determines whether NIP 200 already is aware of a mapping from the UE and/or bearer identifiers to globally known identifiers (e.g. IMSI and/or IP address). It should be understood that the term “globally known identifiers” means identifiers that may be recognized by network equipment outside of the immediate/local network of the UE and/or bearers. For instance, the “globally known identifiers” may be recognized by network equipment and network nodes other than a local base station and MME associated with the UE and/or bearer (and, the “globally known identifiers” may be recognized b network nodes and network equipment that is wholly outside of a service provider's network, as well). In step S312, NIF 200 determines if the identification and state information configuration data is bearer data. The bearer is defined by its classification criteria (e.g., source IP address range, destination IP address range, source port range, destination port range, protocol type, QoS indicator (e.g. DSCP for IPv4) IPSec Security Parameter Index (SPI) and Flow Label (IPv6 only)). A bearer may be defined by multiple instances of the preceding classification criteria. The use of the term bearer identifier can be replaced by its classification criteria. If NIF 200 does not have a mapping, in the event that NIF 200 has never received configuration data from eNB 105 regarding the UE and/or bearer (for instance), NIF 200 queries MME 108 for global identifiers, and the classification criteria that are associated with the UE and/or bearer, as shown in step S314. This message exchange between NIF 200 and MME 108 is shown as a MME request message 303 and MME response message 305 in FIG. 5B. Specifically, NIF 200 sends query 303 to MME 108 that includes the UE identifier received from eNB 105 in message 301), and the query 303 also may include bearer identifiers (see step S308), if applicable.

As shown in S316, a determination is made whether additional information regarding the UE and/or bearer is required that may be gathered from PGW 103. For instance, in the event NIF 200 is unable to obtain an IP address, IMSI or bearer identification (as defined above) of UE 110 and/or bearers, this additional information may be obtained from PGW 103 (or optionally, the information may also be obtained by SGW 101).

In the event that additional information for the UE and/or bearer is necessary, in step S318 NIF 200 may query PGW 103 for this additional information (see this information exchange in PGW request message 307 and PGW response message 309 of FIG. 5B). Specifically, NIF 200 may request the IP address of UE 110, in the event NIF 200 has only the IMSI of UE 110, if NIF 200 is unable to get the IP address information from MME 108. Optionally, NIF 200 may instead poll SGW 101 for this same information, rather than or in addition to polling PGW 103. In the event that additional information for the UE and/or bearer is not necessary, the method proceeds to step S320.

In message 311, eNB 105 periodically or when configured thresholds are met transmits further identification and state information configuration data for an additional time period(s) t, similar to message 301.

In step S320, NIF 200 may analyze the identification and state information UE and/or bearer data, in order to prepare the data for use by AF 114 and/or PCRF 112. This data analysis may include a smoothing of data that is received from the eNB, which may include averaging the data over longer time periods for the AF 114 and PCRF 112 to use m policy or application decisions.

In step S322, the analyzed identification (including the globally recognized identifier) and state information data may be sent from NIF 200 to AF 114 (see message 313 of FIG. 5B), PCRF 112 (see message 315 of FIG. 5B). Alternatively, this information may also he exported to the UE or another network node that is able to adjust throughput to the UE and/or the UE bearers. The analyzed data may include the globally unique identifiers, such as IMSI, IP address, and the bearer identifier (as defined above). It should be understood that this analyzed data may be exported on a periodic basis (either by AF 114, PCRF 112, or another network node polling NIF 200 for the analyzed data, or by NIF 200 independently exporting this data, unilaterally).

As shown in FIG. 5B, in the event that NIP 200 sends the analyzed identification and state information data to PCRF 112, AF 114 may query PCRF 112 for the analyzed data pertaining to a UE and/or bearer of interest, given the IP address and/or IMSI information and optionally the classification criteria (source IP address range, destination IP address range, source port range, destination port range, protocol type, QoS indicator (e.g. DSCP for IPv4) IPSec Security Parameter Index (SPI) and Flow Label (IPv6 only)).

Once AF 114 receives the analyzed identification and state information data for the application software to stream data at a rate at which the eNB can support. This may reduce rate fluctuations, video stalls, and provides video stability which translates to a higher quality of experience to the viewer.

As explained above, the entire FIG. 4-5 method may be repeated on a regular basis in order to continuously update AF 114 with current UE and/or bearer data in order to improve and/or optimize the network. This optimization may include troubleshooting the network, performing operations administrations and management (OAM), performing self-optimizing networks (SON), performing network planning, etc.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A method of exporting user equipment (UE) and/or bearer information, comprising:
receiving, at a processor of a network node, UE and/or bearer state information and at least one locally recognized UE and/or bearer identifier from a base station for at least one UE and/or bearer of the network;
mapping, at the processor, the locally recognized UE and/or bearer identifier to a globally recognized UE and/or bearer identifier, the globally recognized UE and/or bearer identifier being an identifier of a UE and/or bearer that is recognized by network equipment outside of the network; and
exporting, at the processor, the UE and/or bearer state information and the globally recognized UE and/or bearer identifier to a network element.

2. The method of claim 1, wherein the network element is at least one of an application function (AF), a policy and charging rules function (PCRF), the at least one UE, and another network node of the network capable of adjusting the throughput to the UE associated with the at least one UE and/or bearer.

3. The method of claim 1, wherein the globally recognized UE and/or bearer identifier includes at least one of an internet protocol (IP) address, an international mobile subscriber identity (IMSI), and a bearer identifier.

4. The method of claim 1, wherein the UE and/or bearer state information includes at least one of a quality-of-service class indicator (QCI) of a bearer and an average channel quality indicator,
wherein the QCI includes at least one of an average signal-to-noise ratio (SINR), an average channel quality indicator (CQI) as reported by a UE associated with the at least one UE and/or bearer, an average modulation and coding scheme (MCS) as used by a scheduler, and an average transmitted bits sent (TBS) slope index,
wherein TBS slope index is an average ratio of transmitted bits sent per second for the bearer to a number of physical resource blocks allocated by scheduler per second for the bearer.

5. The method of claim 1, wherein the UE and/or bearer state information includes at least one of an average number of bits per second successfully transmitted from or to the UE, average number of bits per second transmitted for the bearer, average number of bits per second transmitted to or from the UE, an average number of physical resource blocks (PRBs) allocated by a scheduler per second for the bearer, an average number of PRBs allocated by a scheduler per second for the UE, an average number of PRBs allocated for data retransmissions for the bearer, an average number of PRBs allocated for data retransmissions for the UE, and an average size of buffered at base station data waiting to be wirelessly transmitted.

6. The method of claim 1, wherein the globally recognized UE and/or bearer identifier is an identifier of a UE and/or bearer that is recognized by network equipment other than a base station and a mobility management entity (MME) associated with the at least one UE and/or bearer.

7. The method of claim 1, wherein the mapping of the locally recognized UE and/or bearer identifier to the globally recognized UE and/or bearer identifier includes,
transmitting a mobility management entity (MME) request message to a MME associated with the base station, the MME request message including the locally recognized UE and/or bearer identifier,
receiving a MME response message from the MME, the MME response message including the globally recognized UE and/or bearer identifier.

8. The method of claim 1, wherein the mapping of the locally recognized bearer identifier to the globally recognized bearer identifier includes,
transmitting a request message to one of a packet data network gateway (PGW) and a serving gateway (SGW) associated with the base station, the request message including the locally recognized UE and/or bearer identifier,
receiving a response message from at least one of the PGW and the SGW, the response message including the globally recognized UE and/or bearer identifier.

9. The method of claim 1, wherein the network node is a stand-alone server within the network, wherein the network is an Internet Protocol (IP) Connectivity Access Network (IP-CAN) network.

10. The method of claim 1, wherein the network node is in a remote location that is outside of the network, wherein the network is an Internet Protocol (IP) Connectivity Access Network (IP-CAN) network.

11. A method of adjusting throughput using bearer information, comprising:
receiving, at a processor of first network node from a second network node, UE and/or bearer state information and at least one globally recognized UE and/or bearer identifier associated with a UE and/or bearer associated with a UE, the globally recognized UE and/or bearer identifier being an identifier of a UE and/or bearer that is recognized by network equipment outside of the network; and
adjusting, at the processor of the first network node, throughput for the UE and/or bearer based on the received UE and/or bearer state information and the at least one globally recognized UE and/or bearer identifier.

12. The method of claim 11, wherein the first network node is an application function (AF).

13. The method of claim 12, wherein the first network node is outside of the network.

14. The method of claim 12, wherein the first network node is the UE.

15. A network node, comprising:
a communication interface configured to receive UE and/or bearer state information and at least one locally recognized UE and/or bearer identifier from a base station for at least one UE and/or bearer of the network; and
a processor configured to,
map the locally recognized UE and/or bearer identifier to a globally recognized UE and/or bearer identifier, the globally recognized UE and/or bearer identifier being an identifier of a UE and/or bearer that is recognized by network equipment outside of the network,
wherein the communication interface exports the UE and/or bearer state information and the globally recognized UE and/or bearer identifier to a network element.

16. The network node of claim 15, wherein the globally recognized UE and/or bearer identifier includes at least one of an internet protocol (IP) address, an international mobile subscriber identity (IMSI), and a bearer identifier.

17. The network node of claim 15, wherein the UE and/or bearer state information includes at least one of a quality-of-service class indicator (QCI) of a bearer, and an average CQI,
wherein the CQI includes at least one of an average signal-to-noise ratio (SINR), an average CQI as reported by a UE associated with the at least one UE and/or bearer, an average modulation and coding scheme (MCS) as used by a scheduler, and an average transmitted bits sent (TBS) slope index,
wherein TBS slope index is an average ratio of transmitted bits sent per second for the bearer to a number of physical resource blocks allocated by scheduler per second for the bearer.

18. The network node of claim 15, wherein the UE and/or bearer state information includes at least one of an average number of bits per second successfully transmitted from or to the UE, average number of bits per second transmitted for the bearer, average lumber of bits per second transmitted to or from the UE, an average number of physical resource blocks (PRBs) allocated by a scheduler per second for the bearer, an average number of PRBs allocated by a scheduler per second for the UE, an average number of PRBs allocated for data retransmissions for the bearer, an average number of PRBs allocated for data retransmissions for the UE, and an average size of buffered at base station data waiting to be wirelessly transmitted.

19. The network node of claim 15, wherein the globally recognized UE and/or bearer identifier is an identifier of a UE and/or bearer that is recognized by network equipment other than a base station and a mobility management entity (MME) associated with the at least one UE and/or bearer.

20. The network node of claim 15, wherein the processor maps the locally recognized UE and/or bearer identifier to the globally recognized UE and/or bearer identifier by being further configured to,
transmit a mobility management entity (MME) request message to a MME associated with the base station, the MME request message including the locally recognized UE and/or bearer identifier,
receive a MME response message from the MME, the MME response message including the globally recognized UE and/or bearer identifier.

21. The network node of claim 15, wherein the processor maps the locally recognized bearer identifier to the globally recognized bearer identifier by being further configured to,
transmit a request message to one of a packet data network gateway (PGW) and a serving gateway (SGW) associated with the base station, the request message including the locally recognized UE and/or bearer identifier,
receive a response message from at least one of the PGW and the SGW, the response message including the globally recognized UE and/or bearer identifier.

22. A first network node, comprising:
a communication interface configured to,
receive, from a second network node, UE and/or bearer state information and at least one globally recognized UE and/or bearer identifier associated with a UE and/or bearer associated with a UE, the globally recognized UE and/or bearer identifier being an identifier of a UE and/or bearer that is recognized by network equipment outside of the network; and
a processor configured to,
adjust throughput for the UE and/or bearer based on the received UE and/or bearer state information and at least one globally recognized UE and/or bearer identifier.
